(19) United States
(12) Patent Application Publication
(10) Pub. No.: US 2015/0332340 A1
(43) Pub. Date: Nov. 19, 2015

(54) METHOD OF CREATING DYNAMIC CUSTOM-TARGETED ADVERTISEMENT CONTENT

(71) Applicants: Wendell BROWN, Henderson, NV (US); Evan Gregory TANN, Manitou Beach, MI (US)

(72) Inventors: Wendell BROWN, Henderson, NV (US); Evan Gregory TANN, Manitou Beach, MI (US)

(21) Appl. No.: 14/714,080

(22) Filed: May 15, 2015

Related U.S. Application Data
(60) Provisional application No. 61/993,996, filed on May 15, 2014.

(51) Int. Cl. G06Q 30/02

(52) U.S. Cl. CPC G06Q 30/0269

(57) ABSTRACT

A method of dynamically generating an advertisement includes collecting information data associated with a viewer, processing the information data to generate a viewer profile, obtaining an intended action from the viewer, generating an advertisement content based on the intended action and the viewer profile, and transmitting the advertisement content to the viewer.

### CROSS-REFERENCE TO RELATED APPLICATIONS

This application claims the benefit of U.S. Provisional Application No. 61/993,996, filed May 15, 2014, entitled “METHOD OF CREATING DYNAMIC CUSTOM-TARGETED ADVERTISEMENT CONTENT,” the content of which is incorporated herein by reference in its entirety.

### BACKGROUND

The present invention relates generally to advertisements, and in particular to a system and method of dynamically creating custom-targeted advertisement content based on an intended or predicted action of a viewer.

Desktop and portable-computing devices such as laptops have been supplemented by portable and wearable-computing devices and mobile devices such as tablets and mobile phones. Portable computing devices contain a variety of sensors and data input devices. Typical information, hereinafter also referred to as “data”, from portable-computing devices includes global positioning system (GPS) location, wireless network status, mobile cell phone tower location, device acceleration, audio inputs, video inputs, fingerprint sensors, temperature sensor, information about other devices associated with the user's portable-computing device, e.g., tethered Bluetooth® devices, and/or like data.

A user of such portable-computing devices may be associated with various online social or other account information, such as Facebook, Twitter, LinkedIn and other similar accounts or networks. Online social account information may include a user's likes and dislikes, e.g., the user's interests. Some online social account information is fed or streamed to a user's portable-computing or wearable-computing device as an information feed based on #hashtags, e.g., keywords, that relate to the user's interests.

An advertisement, hereinafter also referred to as an “ad,” is used to market and sell a product or service. Typical ads contain primary information in the form of text, images, video, and/or audio information about a product or service. The primary information in the ad may also contain information, such as a toll-free 800 number, a website address, a physical street address, or another means of actions that provides a way for the viewer or listener to take an action to either buy the product or obtain more supplemental information related to the ad. Magazine and video ads, roadside billboards, street-level ads, posters in subways or bus stops, digital-out-of-home advertisements, kiosks, ads on vehicles such as taxis, buses, cars, and the like, contain similar information.

The large amount of ads and/or feed information available to the user may be overwhelming. Such ads and/or offering information may not be relevant or ranked according to the user's interests at the user's current time or location, e.g., the user's interests in real-time. New digital advertisement mediums such as web/Internet and mobile phone may allow an advertiser to target specific sectors of viewers (e.g., an age group from 18 years old to 25 years old) in an attempt to more efficient reach a product's target audience. However, the advertisements are static in nature.

### SUMMARY

There exists a need for dynamically creating an advertisement (ad) based on intended or predicted actions of a viewer and displaying the created ad to the viewer in real-time. Certain embodiments of the present invention relate to dynamically generating advertisement based on intended actions of a viewer. In some embodiments, a method of dynamically generating an advertisement includes collecting information data associated with a viewer, processing the information data to generate a viewer profile, obtaining an intended action from the viewer, generating an advertisement content based on the intended action and the viewer profile, and transmitting the advertisement content to the viewer.

Some embodiments provide system for dynamically generating an advertisement. The system includes a processor and a memory coupled to the processor. The memory is configured to store a program executable by the processor and operable to perform: collect information data associated with a viewer, process the information data to generate a viewer profile, obtain an intended action from the viewer, generate an advertisement in response to the intended action, and transmit the advertisement to the viewer.

In some embodiments, the viewer profile includes a plurality of attributes stored within a database.

In some embodiments, the method further includes determining a result based on an action of the viewer after viewing the advertisement, correlating the result with the stored attributes, and updating the attributes stored within the database.

In some embodiments, the method further includes generating a second advertisement in response to the action.

In some embodiments, the attributes are associated with a social graph associated with the viewer.

In some embodiments, the advertisement is associated with an environmental condition.

In some embodiments, the environmental condition is associated with a location of the viewer.

In some embodiments, the advertisement is associated with an available inventory.

The following description, together with the accompanying drawings, will provide a better understanding of the nature and advantages of the claimed invention.

### BRIEF DESCRIPTION OF THE DRAWINGS

FIG. 1 is a simplified block diagram of a server computer according to an exemplary embodiment of the present invention.

FIG. 2 is a simplified block diagram of a system for dynamically generating custom-targeted ad content according to an embodiment of the present invention.

FIG. 3 is a simplified block diagram of a portable or wearable-computing device according to an exemplary embodiment of the present invention.

FIG. 4 is a simplified block diagram of a system for dynamically generating a custom-targeted ad content based on a viewer's intended action according to an exemplary embodiment of the present invention.

FIG. 5 is a flow chart illustrating a method of dynamically generating a custom-targeted ad content based on a viewer's intended action according to an exemplary embodiment of the present invention.

FIG. 6 depicts a simplified block diagram of a computer system that may incorporate embodiments of the present invention.

### DETAILED DESCRIPTION

As used herein, the term “advertisement” (“ad” hereinafter) includes content, data or information, promotional items, and brands that are designed by a firm or individual for distribution with the intent of driving some actions or awareness. An ad can be presented to a viewer in plain text, graphics, video, audio, multimedia data, and any combination thereof. The terms “article,” “products,” and “services” can be used interchangeably. The terms “device” and “module” can be used interchangeably. The terms “computer system,” “system,” “host,” “engine,” and “server” can be used interchangeably. The term “computer-readable medium” refers to any medium that participates in providing software (sets of instruction, data structures, program codes), which may be read and executed by a computer. The terms “a,” “an,” and “the” may include singular and plural references.

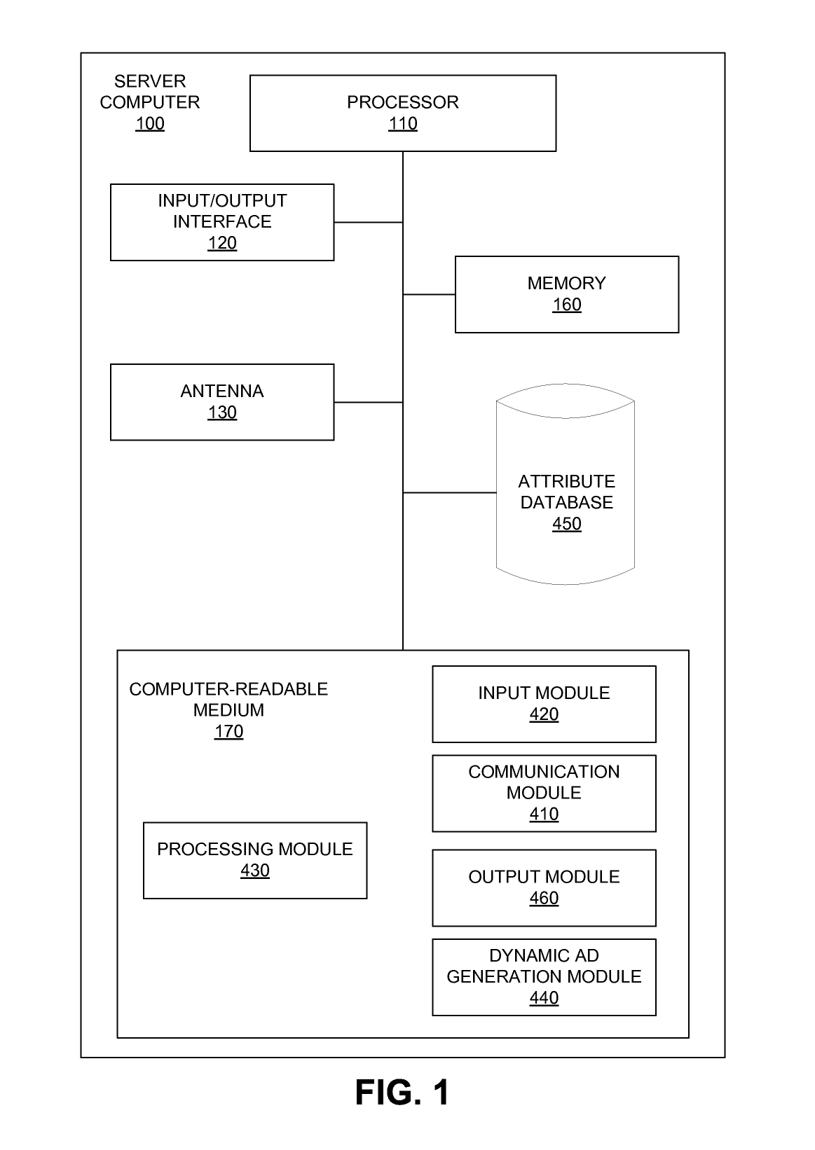

FIG. 1 is a block diagram of a server computer 100, according to some embodiments of the present invention. Server computer 100 includes an input/output interface 120, a memory 160, a processor 110, antenna 130, attribute database 450, and a computer-readable medium 170. In some embodiments, the server computer 100 may reside within an interconnected network.

The input/output (I/O) interface 120 is configured to allow the server computer 100 to receive and transmit data, from any of the entities described herein.

Memory 160 may be any magnetic, electronic, or optical memory. It can be appreciated that memory 160 may include any number of memory modules, that may comprise any suitable volatile or non-volatile memory devices. An example of memory 160 may be dynamic random access memory (DRAM).

Processor 110 may be any suitable processor operable to carry out instructions on the server computer 100. The processor 110 is coupled to other units of the server computer 100 including input/output interface 120, memory 160, antenna 130, and attribute database 450.

Computer-readable medium 170 may be any magnetic, electronic, optical, or other computer-readable storage medium. Computer-readable storage medium 340 includes communication module 410, input module 420, processing module 430, dynamic ad generation module 440, and output module 460. Computer-readable storage medium 340 may comprise any combination of volatile and/or non-volatile memory such as, for example, buffer memory, RAM, DRAM, ROM, flash, or any other suitable memory device, alone or in combination with other data storage devices.

In some embodiments, the server computer 100 may be operated by an advertiser to generate dynamic custom-targeted advertisement content. In some embodiments, the server computer 100 may be operated by a third-party to generate the same.

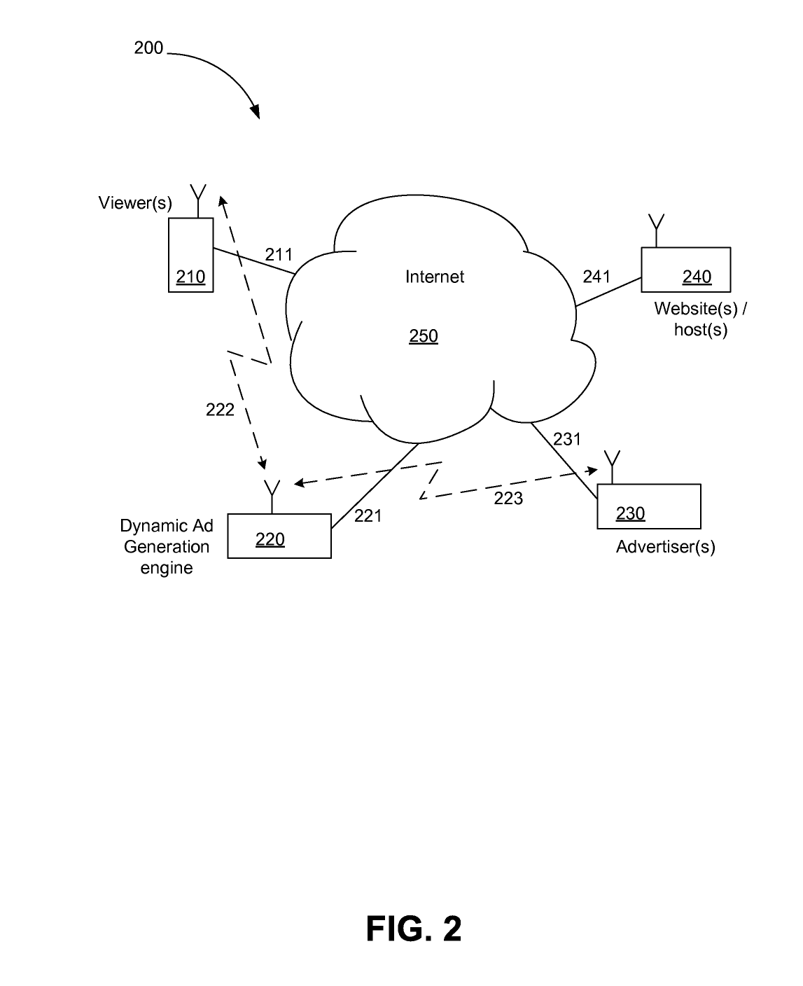

FIG. 2 is a simplified block diagram of a system 100 for dynamically generating custom-targeted ad content based on intended actions of a viewer, in accordance with some embodiments. System 200 includes a viewer 210, a dynamic ad content generation engine 220, an advertiser 230, and a website or host 240. Viewer 210, dynamic ad content generation engine 220, advertiser 230 and website 240 can communicate with each other through a communication network 250. Communication network 250 can be a wireless or a wired local area network (LAN) network, a metropolitan area network (MAN), a wide area network (WAN) or any combinations thereof. Viewer 210, dynamic ad generation engine 220, advertiser 230, and website 240 may be connected to communication network 250 (e.g., Internet) through respective communication links 211, 221, 231, and 241, which can be a wireless (WiFi, Bluetooth, cellular RF), a wire (cable, optical fiber, copper) link or a combination thereof. In some embodiments, viewer 210, dynamic ad generation engine 220, advertiser 230, and website 240 can communicate directly with each other without going through communication network 250 as indicated by broadcast links 222, 223, etc.

Viewer(s) 210 may include any potential viewer of an advertisement or target of an advertisement. The viewer may be a user of a television, smart phone, computer, or any other medium capable of viewing advertisements.

Website/host 240 may include any systems capable of storing and transmitting digital content and contains any number of web pages. A website/host may include a set of related web pages typically served from a single web domain. A website may be hosted on at least one web server, accessible via a network such as the Internet or a private local area network through an Internet address known as a uniform resource locator (URL). All publicly accessible websites may collectively constitute the World Wide Web.

Advertiser 230 may be a traditional ad creating firm. The advertiser 230 may create marketing and advertising which uses the Internet to deliver promotional marketing messages to viewer(s) 210. The marketing and advertising may include email marketing, search engine marketing (SEM), social media marketing, many types of display advertising (including web banner advertising), and mobile advertising. Like other advertising media, online advertising may frequently involve both a publisher, who integrates advertisements into its online content, and an advertiser, who provides the advertisements to be displayed on the publisher's content. In some embodiments, advertiser 230 may function as both the publisher and the advertiser. Other potential participants include advertising agencies who help generate and place the ad copy, an ad server which technologically delivers the ad and tracks statistics, and advertising affiliates who do independent promotional work for the advertiser 230. In some embodiments, the dynamic ad generation engine 220 can be located remote at remote locations or it can be located (integrated) with advertiser 230 or host 240.

Dynamic ad generation engine 220 may be configured to dynamically generate custom-targeted ad content based on intended actions of the viewer(s) 210. The generated ad content may be customized or targeted to the viewer(s) 210. The dynamic ad generation engine 220 may receive inputs that include, but is not limited to, product purchase intent, user's location, time of day/week, viewer's personal tastes, etc. Additionally, a potential advertiser's 230 brand colors, logo, spokesperson, etc. can be used as inputs to the dynamic ad generation engine 220. The dynamic ad generation engine 220 may then generate a custom-targeted advertisement content based on the input(s), intended to be displayed to the user.

In the example shown in FIG. 2, only a viewer, a website or host, and an advertiser are shown for the sake of simplicity. However, it is understood that system 200 can include any number of viewers, hosts, ad content generation engines, and advertisers and should not be limiting. It is to be understood that the terms of website/host, advertiser, and dynamic ad content generation engine are only used to distinguish one system from another, each of them can be implemented as one or more servers having one or more processing units and storage units for performing the intended applications.

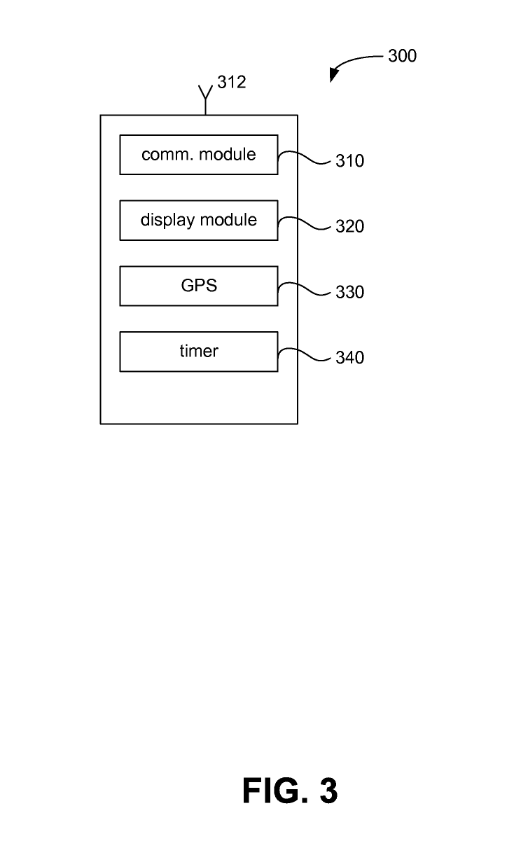

FIG. 3 is a simplified block diagram of a viewer portable or wearable computing device 300 according to some embodiments. Device 300 may be a smartphone, a PDA, a tablet PC, television, computer, smartwatch, and the like. Device 300 may include a communication module 310 coupled to an antenna 312, a display module 320 including a touch panel, a GPS module 330 configured to provide a location of the viewer, and a timer 340 configured to provide time of day and/or day of week.

Communication module 310 may be configured to communicate with another device via the Internet. Communication module 310 may interface with antenna 312 to facilitate any communications. Display module 320 may be configured to display content to the viewer(s) 210. The content can include, e.g., advertisement content.

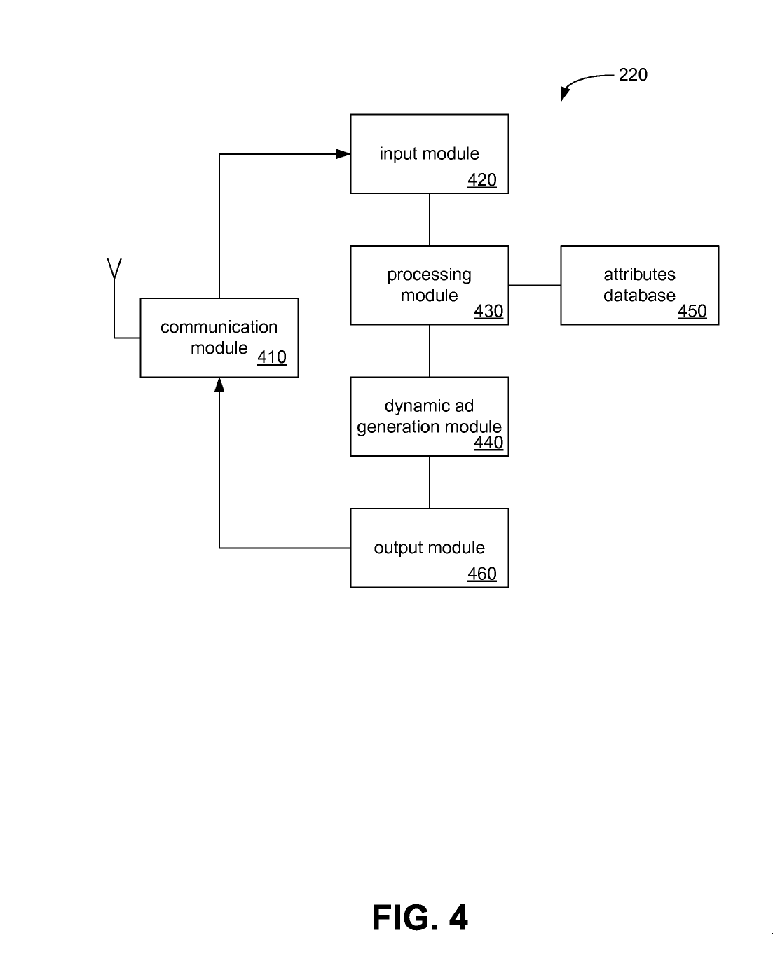

FIG. 4 is a simplified block diagram of a dynamic ad content generation engine 220 according to some embodiments. Ad content generation engine 300 may include a communication module 410 configured to operatively couple to viewer(s) 210 device, advertiser 230, and website/host 240 through a wireless link and/or via communication network 250. Ad content generation engine 220 may also include an input module 420 coupled to communicative module 410, a processing module 430 coupled to input module 420, an ad content generation module 440 coupled to processing module 430, an output module coupled to ad content generation module 440. Communication module 410 may enable the ad content generation engine to communicate with different devices (viewer devices 410, advertisers 430, websites/hosts 440) via network 450. Input module 420 is configured to receive data from communicative module 410 and forward the received data to processing module 430 for further processing.

In some embodiments, the received data may include a viewer's stated personal preferences. For example, the viewer's stated preferences may include his/her favorite color, favorite food type, favorite media objects such as picture(s) of his/her best friend, recent favorite song, music or Pandora channels, songs purchased from iTunes or other digital purchases, favorite TV shows, favorite musicians, favorite celebrities, web product or service purchases, favorite coffee store logo, etc.

In some embodiments, the dynamic ad generation engine may provide a fee-based or free subscription service to a viewer. A viewer (e.g., subscriber) can access the dynamic ad generation engine's website to enter his/her personal information and preferences. For example, the dynamic ad generation engine's web site may have a page that includes fields for personal information such as name, age, gender, marital status, preferences, social networks that the viewer voluntarily provides. The viewer (subscriber) may allow the dynamic ad generation engine to receive all messages sent and received by his/her portable device for processing. In another embodiment, dynamic ad content generation engine 220 may collect a viewer's data using a multitude of different sources such as the viewer's name, residential address, cellular service provider, Internet service provider, viewer's email id, web sites and web pages that the viewer has visited, viewer's social media sites, blogs, emails, video and other forms of media. In yet another embodiment, a viewer's personal information data and preferences can be collected by a separate service (a third party), and the collected information data and preferences of the viewer are fed into dynamic ad content generation engine 220. Separate service may be contained or considered part of the complete ad response product or a completely separate process/product.

In some embodiments, the received data may include a viewer's friend graph, social graph, or historical person-connect history (via emails, phone calls, text messages, etc.).

In some embodiments, the received data may include a viewer's stated or inferred purchase intents (e.g., “I want to buy this item” statements, “anyone wants to go buy a coffee” broadcasts or messages, web product search actions, etc.).

In some embodiments, the received data may include a viewer's historical actions (e.g., web browsing history, his/her mobile phone background color settings, his/her prior GPS location tracks of his/her locations, his/her recent purchases or personal merchant visits, etc.).

In some embodiments, the received data may include a viewer's prior or historical purchase information (e.g., prior credit card purchases, prior purchases from web merchants, songs purchased from digital music stores, other digital purchases, web product or service purchases, etc.)

In some embodiments, the received data may include a viewer's prior media consumption preferences and/or historical media consumption patterns (e.g. which YouTube channels they're subscribed to, which musical concerts they've purchased tickets to, which TV shows they watch, which music or Pandora channels they listen to, songs purchased from iTunes or other digital purchases, favorite TV shows, favorite musicians, favorite celebrities, web product or service purchases, etc.)

In some embodiments, the received data may include a viewer's predicted or stated future activities (e.g., I'm going to see a baseball game tonight, I'm going out with my best friend Jack, etc.).

In some embodiments, a viewer may access the dynamic ad generation engine's web site and enter his/her personal information and preferences. For example, the dynamic ad generation engine's web site may have a page that includes fields for personal information such as name, age, gender, marital status, preferences, social networks that the viewer voluntarily provides.

In some embodiments, processing module 430 may process the received data and extract attributes associated with a viewer's stated personal preferences, favorite media objects, history of purchase information and web browsing activities, friend graph, social graph, friends' names and pictures, and others. The attributes may include a viewer's name, residential address, gender, education, viewer's multiple mobile devices and models, cellular service provider, Internet service provider, emails id(s), log activities, web searches, search topics, etc. The extracted attributes may be stored in a database 450. In some embodiments, database 450 may be co-located with ad content generation engine 220. In some embodiments, database 450 may be located in a remote location away from ad content generation engine 220.

In some embodiments, ad content generation module 440 computes a predicted “best match” of output ad content and styles then renders the output media (a video, a picture, text, sound, etc.) based on those attributes. For example, if the predicted ad content is a sport car whose original image has been designed and stored, the sport car may be rendered with a red color with real-time or near real-time for viewing. The rendering may be performed by ad content generation module 440. In another embodiment, the ad rendering can be performed by a viewer's device. The predicted and stated future actions of the viewer may be stored in the database 450, in a cache at a commercial third party, or in other digital storages of an advertiser.

In some embodiments, output module processes or formats the output content and styles to match a viewer's display module (e.g., according to viewer's mobile phone device, model number, screen size, and the like). Output module 460 may also render a viewers' 2D and 3D favorite media objects onto specific locations within the media. For example, a Starbucks logo would be applied, using 3D rendering techniques, onto the “blank” area of a shown coffee cup (in a video or picture) to customize that coffee cup with the Starbucks logo. In a video example, as the coffee cup moves, the 3D-applied/rendered logo would move along with the cup, changing perhaps the 3D location/positioning of the applied logo.

In some embodiments, dynamic ad content generation engine 220 may customize an ad content with available or nearby in-store inventory received from advertiser 230 or website/host 240. In an embodiment, dynamic ad content generation engine 220 may modify the original created ad by the advertisers with real-time or near real-time suggestions. For example, if an advertiser creates “Drink Coke with ______,” dynamic ad content generation engine 220 may fills in the blank with a friend of the viewer.

In some embodiments, dynamic ad content generation engine 220 may customize an ad content with inventory available online.

In some embodiments, dynamic ad content generation engine 220 may customize an ad content with items or brands a viewer intends to purchase or has purchased.

In some embodiments, dynamic ad content generation engine 220 may measure the resulting success of the generated ad content by determining how well a target viewer responds to the ad. For example, if the ad content is a show, and the viewer purchases a ticket to see the show after receiving the ad, then the ad result is considered positive. In an embodiment, ad content generation engine 220 may send a survey asking the target viewer to provide feedback after receiving the ad. In another example, if the generated ad recommends a certain store based on the viewer's intended action, and the location identification module (GPS module 330) of the viewer's device confirms the viewer's position, the module may automatically trigger the viewer's device to send a feedback to the dynamic ad content generation engine to update the viewer attributes.

In some embodiments, ad content generation engine 220 may further correlate the received feedback and the resulting success to adjust the attributes based on a mathematical algorithm. Ad content generation engine 220 may adjust the attributes by assigning a weight to the viewer's various attributes associated with the resulting success and combining the weighted attributes to update the viewer's profile. The weighted attributes may be stored at the local attribute database 450 or at a remote database.

In some embodiments, elements of the ad content generation engine 220 may be implemented by server computer 100.

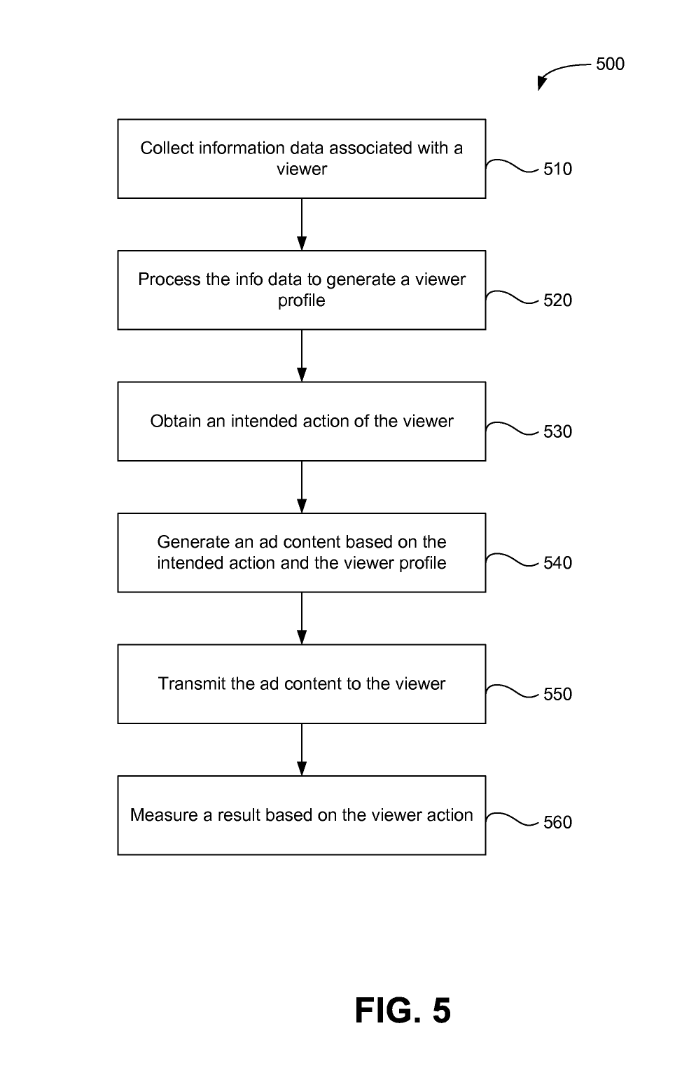

FIG. 5 is a flow chart illustrating a method 500 of dynamically generating a custom-targeted ad content, according to some embodiments. Method 500 includes collecting information data associated with a viewer at block 510. For example, a viewer may want to subscribe to the ad generation engine's service by accessing the website to enter his personal information and preferences. The inputted information data may include but not limited to his age, gender, hobbies, history of product purchases from web merchants, his friend graph, social graph, friend names, pictures time until stated intention, weather, nearby merchant distance and operating hours, nearby friends, etc. At block 520, method 500 includes processing the entered information data to generate a viewer profile. The profile may contain a multitude of attributes such as historical preferences, brand alignments (products and service purchases), a list of recent contacts, records of recent visited websites, history of the viewer's activities, etc. At block 530, the method includes obtaining an intended action of the viewer. For example, the intended action can be obtained by parsing messages sent by and received from the portable/wearable device of the viewer and identified by one or more keywords. At block 540, method 500 includes generating a customized ad content based on the intended action and the viewer profile. At block 550, method 500 includes transmitting the ad content to the viewer's device for display. Method 500 also includes determining the action taken by the viewer after having viewed the displayed ad content. For example, the duration that the viewer spends in each website can be measured. For example, if the viewer's intended action is to attend a musical concert, the method will generate a customized ad content showing advertisements of musical plays offered. If the viewer bought a ticket after viewing the ad content, the method may measure the result based on the action taken and correlate the result (in this case a success of the generated custom ad content) with prior stored results and update the attributes stored in a database accordingly. Based on the action taken by the viewer, the method may further generate a second customized ad content. For example, after the viewer purchases a ticket to the concert, the new ad content may display restaurants near the concert that match the viewer's taste so that the viewer can enjoy a meal before or after the musical performance. The method may assign a high quality factor (weight) to the viewer's most recent activities and a low quality factor to the stale activities to update the attributes to generate an updated profile.

In an embodiment, the attributes may also be updated based on the viewer's friends or friend's likes, and use this information to correlate and weight data inputs.

In an embodiment, the list of a viewer's soon-to-be, currently-seen, or recently-seen advertisement content is ranked according to various criteria such as advertiser's fee rate, time since viewer was likely impressed/impacted by that ad, relevancy of that advertisement to the user's predicted or historical interest, and/or other criteria.

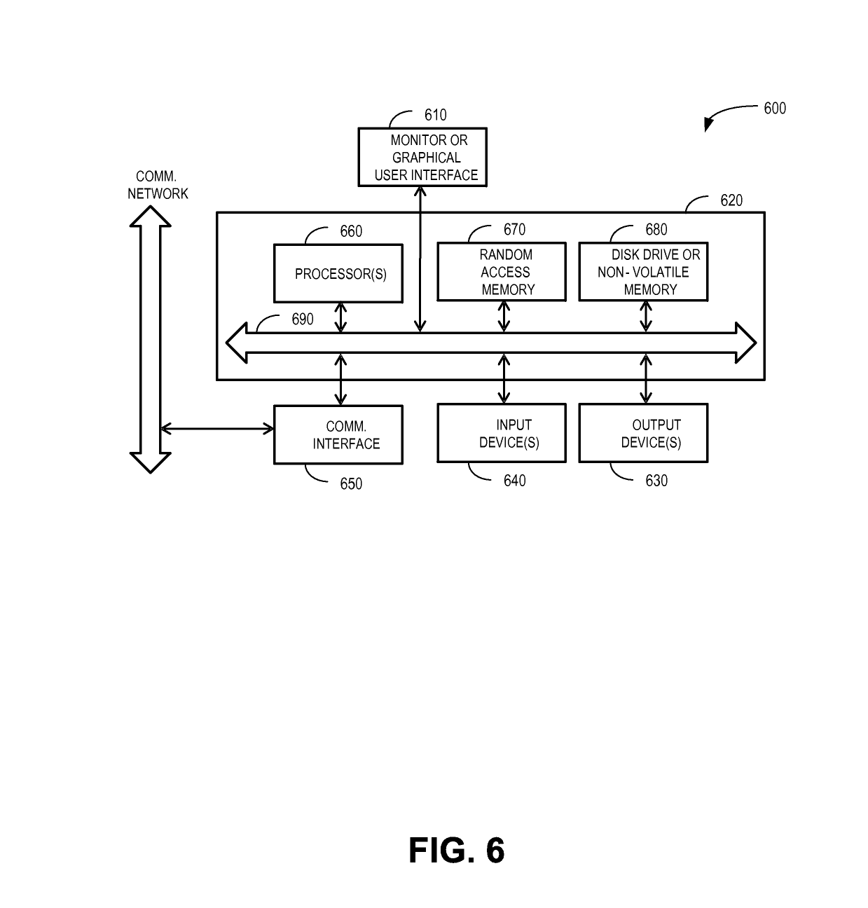

FIG. 6 is a simplified block diagram of a computer system that may incorporate embodiments of the present invention. FIG. 6 is merely illustrative of an embodiment incorporating the present invention and does not limit the scope of the invention as recited in the claims. One of ordinary skill in the art would recognize other variations, modifications, and alternatives.

In one embodiment, computer system 600 typically includes a monitor 610, a computer 620, user output devices 630, user input devices 640, communications interface 650, and the like. Computer system 600 may also be a smart phone, tablet-computing device, and the like, such that the boundary of computer 620 may enclose monitor or graphical user interface 610, user output devices 630, user input devices 640, and/or communications interface 650.

As shown in FIG. 6, computer 620 may include a processor(s) 660 that communicates with a number of peripheral devices via a bus subsystem 690. These peripheral devices may include user output devices 630, user input devices 640, communications interface 650, and a storage subsystem, such as random access memory (RAM) 670 and disk drive or non-volatile memory 680.

User input devices 630 include all possible types of devices and mechanisms for inputting information to computer system 620. These may include a keyboard, a keypad, a touch screen incorporated into the display, audio input devices such as voice recognition systems, microphones, and other types of input devices. In various embodiments, user input devices 630 are typically embodied as a computer mouse, a trackball, a track pad, a joystick, wireless remote, drawing tablet, voice command system, eye tracking system, and the like. User input devices 630 typically allow a user to select objects, icons, text and the like that appear on the monitor or graphical user interface 610 via a command such as a click of a button, touch of the display screen, or the like.

User output devices 640 include all possible types of devices and mechanisms for outputting information from computer 620. These may include a display (e.g., monitor or graphical user interface 610), non-visual displays such as audio output devices, and the like.

Communications interface 650 provides an interface to other communication networks and devices. Communications interface 650 may serve as an interface for receiving data from and transmitting data to other systems. Embodiments of communications interface 650 typically include an Ethernet card, a modem (telephone, satellite, cable, ISDN), (asynchronous) digital subscriber line (DSL) unit, FireWire interface, USB interface, and the like. For example, communications interface 650 may be coupled to a computer network, to a FireWire bus, or the like. In other embodiments, communications interfaces 650 may be physically integrated on the motherboard of computer 620, and may be a software program, such as a software-defined DSL, or the like. Embodiments of communications interface 650 may also include a wireless radio transceiver using radio transmission protocols such as Bluetooth®, WiFi®, cellular, and the like.

RAM 670 and disk drive or non-volatile memory 680 are examples of tangible media configured to store data such as embodiments of the present invention, including executable computer code, human readable code, or the like. Other types of tangible media include floppy disks, removable hard disks, optical storage media such as CD-ROMS, DVDs and bar codes, semiconductor memories such as flash memories, read-only-memories (ROM), battery-backed volatile memories, networked storage devices, and the like. RAM 570 and disk drive or non-volatile memory 680 may be configured to store the basic programming and data constructs that provide the functionality of the present invention.

Software code modules and instructions that provide the functionality of the present invention may be stored in RAM 670 and disk drive or non-volatile memory 680. These software modules may be executed by processor(s) 660. RAM 670 and disk drive or non-volatile memory 680 may also provide a repository for storing data used in accordance with the present invention.

RAM 670 and disk drive or non-volatile memory 680 may include a number of memories including a main random access memory (RAM) for storage of instructions and data during program execution and a read only memory (ROM) in which fixed instructions are stored. RAM 670 and disk drive or non-volatile memory 680 may include a file storage subsystem providing persistent (non-volatile) storage for program and data files. RAM 670 and disk drive or non-volatile memory 680 may also include removable storage systems, such as removable flash memory.

Bus subsystem 690 provides a mechanism for letting the various components and subsystems of computer 620 communicate with each other as intended. Although bus subsystem 690 is shown schematically as a single bus, alternative embodiments of the bus subsystem may utilize multiple busses or switches.

Various embodiments of the present invention can be implemented in the form of logic in software or hardware or a combination of both. The logic may be stored in a computer readable or machine-readable non-transitory storage medium as a set of instructions adapted to direct a processor of a computer system to perform a set of steps disclosed in embodiments of the present invention. The logic may form part of a computer program product adapted to direct an information-processing device to perform a set of steps disclosed in embodiments of the present invention. Based on the disclosure and teachings provided herein, a person of ordinary skill in the art will appreciate other ways and/or methods to implement the present invention.

The present invention is not limited to the above described embodiments. The invention is intended to cover all modifications and equivalents within the scope of the appended claims.

What is claimed is:

1. A computer-implemented method for dynamically generating an advertisement, the method comprising:
collecting information data associated with a viewer;
processing, via one or more processing units, the information data to generate a viewer profile associated with the viewer;
obtaining an intended action from the viewer;
generating, via the one or more processing units, an advertisement based on the intended action and the viewer profile; and
transmitting the advertisement to the viewer.

2. The computer-implemented method of claim 1, wherein the viewer profile comprises a plurality of attributes stored within a database.

3. The computer-implemented method of claim 2, further comprising:
determining a result based on an action of the viewer after viewing the advertisement;
correlating the result with the stored attributes; and
updating the attributes stored within the database.

4. The computer-implemented method of claim 3, further comprising generating a second advertisement in response to the action.

5. The computer-implemented method of claim 2, wherein the attributes are associated with a social graph associated with the viewer.

6. The computer-implemented method of claim 1, wherein the advertisement is associated with an environmental condition.

7. The computer-implemented method of claim 6, wherein the environmental condition is associated with a location of the viewer.

8. The computer-implemented method of claim 1, wherein the advertisement is associated with an available inventory.

9. A system for dynamically generating an advertisement, the system comprising:
a processor;
a memory coupled to the processor;
wherein the memory is configured to store a program, executable by the processor, for implementing a method comprising:
collecting information data associated with a viewer;
processing, via one or more processing units, the information data to generate a viewer profile associated with the viewer;
obtaining an intended action from the viewer;
generating, via the one or more processing units, an advertisement based on the intended action and the viewer profile; and
transmitting the advertisement to the viewer.

10. The system of claim 9, wherein the viewer profile comprises a plurality of attributes stored within the memory.

11. The system of claim 10, wherein the method further comprises:
determining a result based on an action taken by the viewer in response to the advertisement;
correlating the result with the stored attributes; and
updating the attributes stored within the memory.

12. The system of claim 11, wherein the method further comprises generating a second advertisement in response to the action.

13. The system of claim 10, wherein the attributes are associated with a social graph associated with the viewer.

14. The system of claim 9, wherein the advertisement is associated with an environmental condition.

15. The system of claim 14, wherein the environmental condition is associated with a location of the viewer.

16. The system of claim 9, wherein the advertisement is associated with an available inventory.

17. One or more non-transitory computer-readable media storing computer-executable instructions for dynamically generating an advertisement that, when executed, cause one or more computing devices to:
collect information data associated with a viewer;
process, via one or more processing units, the information data to generate a viewer profile associated with the viewer;
obtain an intended action from the viewer;
generate, via the one or more processing units, an advertisement based on the intended action and the viewer profile; and
transmit the advertisement to the viewer.

18. The non-transitory computer-readable media of claim 17, wherein the viewer profile comprises a plurality of attributes stored within a database.

19. The non-transitory computer-readable media of claim 18, further comprising:
determining a result based on an action of the viewer after viewing the advertisement;
correlating the result with the stored attributes; and
updating the attributes stored within the database.

20. The non-transitory computer-readable media of claim 19, further comprising generating a second advertisement in response to the action.
